(19) United States
(12) Patent Application Publication
(10) Pub. No.: US 2009/0064129 A1
(43) Pub. Date: Mar. 5, 2009

(54) SUSPEND AND RESUME MECHANISMS ON A FLASH MEMORY

(75) Inventors: Wen-Chih Chen, Taipei City (TW); I-Kuei Tseng, Hsinchu Country (TW); Jui-Hung Weng, MiaoLi County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 11/848,288

(22) Filed: Aug. 31, 2007

(51) Int. Cl. G06F 9/44

(52) U.S. Cl. 717/173

(57) ABSTRACT

An apparatus for providing a file to a target device comprises a communication controller and a processor. The processor acquires download status indicating that a portion of the file has been successfully programmed in nonvolatile memory of the target device, determines a resuming point of the file according to the acquired download status, and transmits a portion of the file from the determined resuming point to the target device via the communication controller. The portion of file is programmed in the nonvolatile memory of the target device.

### BACKGROUND OF THE INVENTION

1. Field of the Invention

The invention relates to suspend and resume mechanisms, and in particular relates to suspend and resume mechanisms between a download device and a consumer electronic device.

2. Description of the Related Art

Conventionally, when data transmission between a download device and a target device is interrupted because of power failure or transmission port jam, the download device requires retransmission of all data to the target device. In this situation, the download device needs to spend redundant time re-transmitting data to the target device and the target device needs to spend redundant time and costs receiving data therefrom and storing the received one in non-volatile memory again.

### BRIEF SUMMARY OF THE INVENTION

A detailed description is given in the following embodiments with reference to the accompanying drawings.

An embodiment of an apparatus for providing a file to a target device is provided. The apparatus comprises a communication controller and a first processor. The first processor acquires download status indicating that a portion of the file has been successfully programmed in nonvolatile memory of the target device, determines a resuming point of the file according to the acquired download status, and transmits a portion of the file from the determined resuming point to the target device via the communication controller. The portion of file is programmed in the nonvolatile memory of the target device.

An embodiment of an apparatus for receiving a file from a source device is provided. The apparatus comprises a communication controller, a nonvolatile memory and a second processor. The second processor acquires a portion of the file from the source device via the communication controller, programs the acquired portion of the file in a predetermined region of the nonvolatile memory, and stores a download status indicating that the portion of the file has been successfully programmed in the nonvolatile memory. Thus, avoiding the programmed portion of the file to be re-acquired and re-programmed after an unexpected event has occurred.

### BRIEF DESCRIPTION OF THE DRAWINGS

The invention can be more fully understood by reading the subsequent detailed description and examples with references made to the accompanying drawings, wherein:

FIG. 1 is a schematic connection diagram of a personal computer communicating with mobile phones according to an embodiment of the invention;

FIG. 2 is a schematic diagram illustrating occurrence of an exceptional situation while programming according to an embodiment of the invention;

FIG. 3 is a schematic diagram illustrating an image BIN (binary) file downloaded between a personal computer and a target device;

FIG. 4 is a sequence diagram illustrating an image BIN file downloaded between executed Boot ROM dll and target DA (download agent) according to an embodiment of the invention;

FIG. 5 is a sequence diagram of illustrating download resuming between executed Boot ROM dll and target DA according to an embodiment of the invention; and

FIG. 6 is a flowchart illustrating download resuming according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

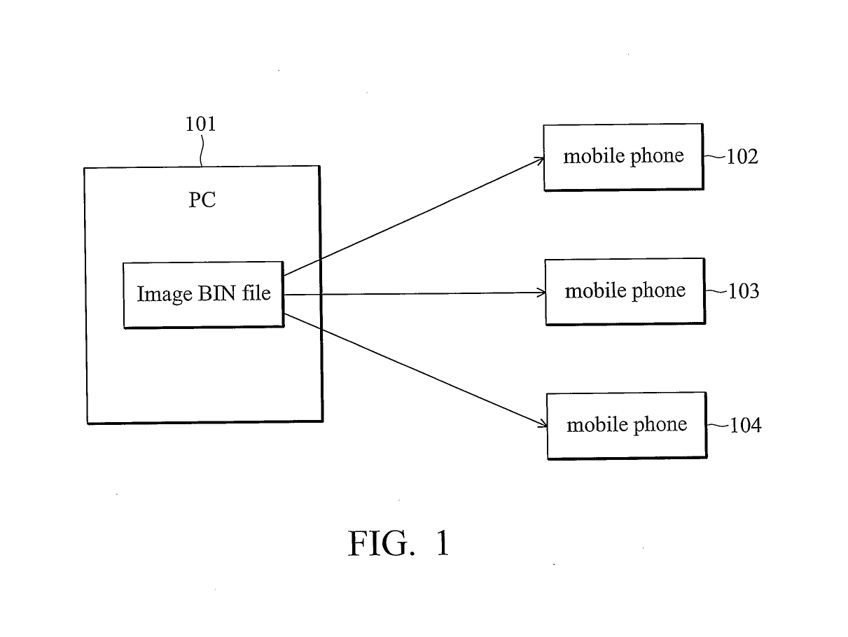

FIG. 1 is a schematic connection diagram of a personal computer 101 communicating with mobile phones 102, 103 and 104 according to an embodiment of the invention. Personal computer 101 may simultaneously transmit image BIN files to nonvolatile memories, such as flash memories, of mobile phones 102, 103 and 104. Those skilled in the art may realize different but similar consumer electronic devices, such as smart phones, portable media players, digital cameras, personal digital assistants (PDA) or others, communicating with the personal computer 101 to acquire new image BIN (binary) files, or newer versions of image BIN files.

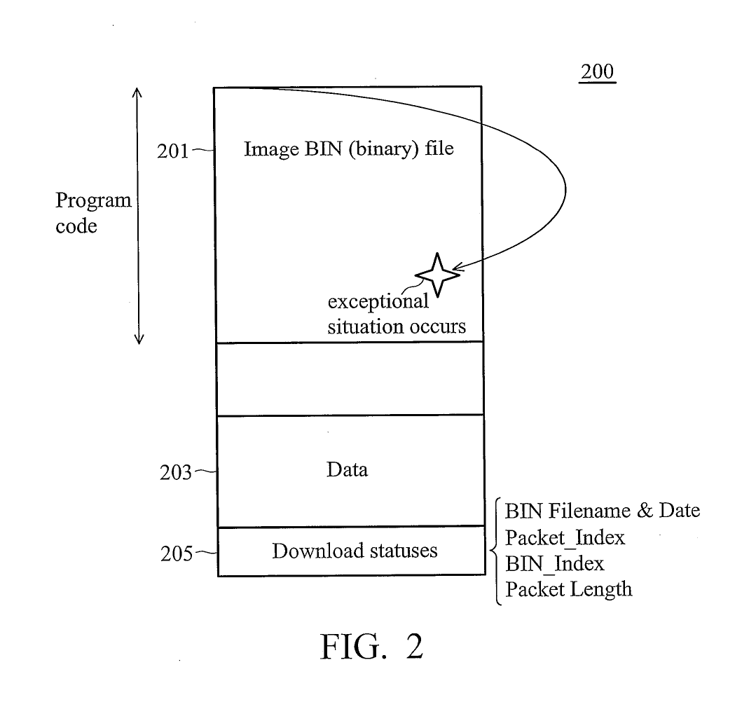

FIG. 2 is a schematic diagram illustrating occurrence of an exceptional situation while programming according to an embodiment of the invention. An embodiment of a nonvolatile memory 200 of a target device comprises three regions 201, 203 and 205 respectively storing image BIN (binary) files, data and download statuses. Download statuses may store information corresponding to a file name corresponding to the stored image BIN files, dates or versions of the stored BIN files, packet length (“Packet_Length”) and information corresponding to the last programming address (“Bin_Index” and “Packet_Index”) or others. The download statuses may be stored in the end of the nonvolatile memory 200 in order to prevent exceptional damage during programming. Information regarding dates or versions of the stored image BIN files may be utilized to determine whether the stored image BIN files have the same versions as that of image BIN files to be downloaded. Each stored date represents creating or establishing date of a corresponding image BIN file, with an earlier date indicating an older image BIN file. Versions may be presented by a serial number for code compiling, assembling and linking, with a smaller number indicating an older image BIN file. Personal computer 310 may acquire the download statuses (originally maintained in 205 of FIG. 2) by requesting the mobile phone, and retransmit the remaining portion of image BIN files from a resuming point determined according to the requested download statuses to the target device via communication controller. During download, each image BIN file is segmented into multiple packets. Each packet has a payload encapsulating a portion of an image BIN file, as well as a checksum for ensuring the data integrity while transmission. Information regarding a payload length in each packet (“Packet_Length”) is stored in the region for download statuses 205. Moreover, “BIN_Index” represents that a particular image BIN file is being downloaded, and “Packet_Index” corresponds to the last portion of image BIN file has been successfully downloaded. When the download process is interrupted exceptionally, a resuming point of the remaining portion of the image BIN identified by the stored “BIN_Index” can be estimated with reference to the stored “BIN_Index”, “Packet_Index” and “Packet_Length”. Details of the estimation are to be described in the following.

In addition, image BIN files are 8-bits format files so that each byte holds one of 256 different binary codes. Image BIN files may contain operation system (OS) for a particular consumer electronic device, background and iconic images, font characters and the similar for UI display, and audio bitstreams played when detecting incoming calls from an associated base station. Thus, the stored BIN files may comprise OS BIN files, audio BIN files, font BIN files or image BIN files, or any combinations thereof. The BIN files are stored continuously in a physical region of a nonvolatile memory (e.g. 201 of FIG. 2). It is to be understood that the physical regions of the mobile phones 102, 103 and 104 for storing the image BIN files, and arrangements of image BIN files therein are the same. Note that, the entire programming process may be interrupted because of power failure or transmission port jam, resulting in incomplete image BIN files.

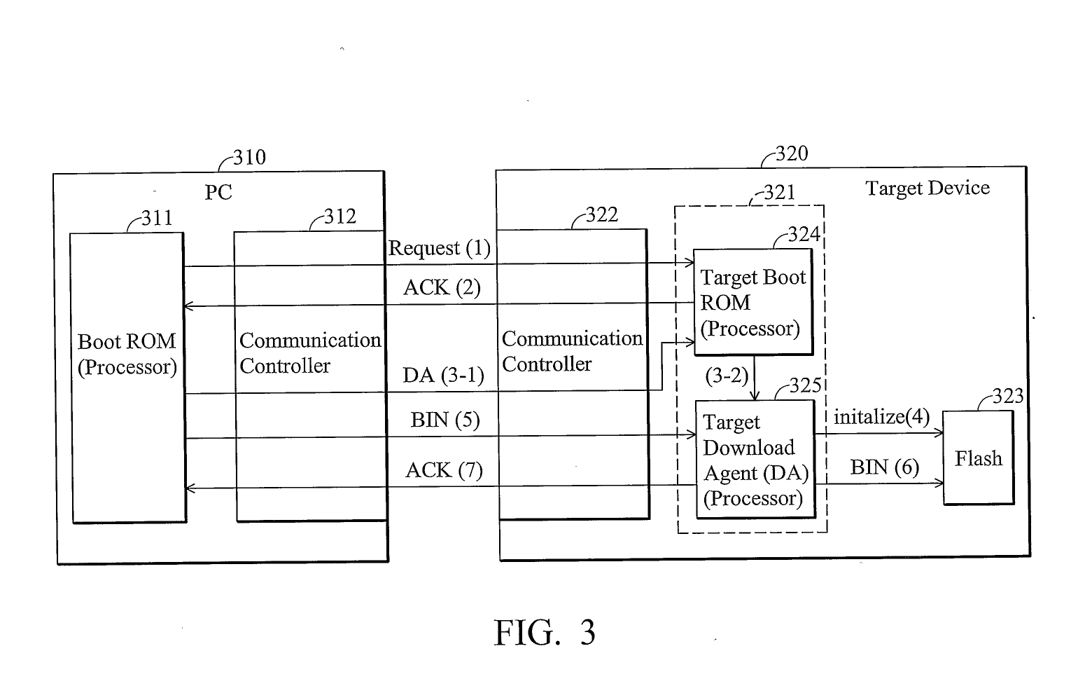

FIG. 3 is a schematic diagram illustrating an image BIN file downloaded between a personal computer 310 and a target device 320, such as a mobile phone, a smart phone and the similar, according to an embodiment of the invention. The personal computer 310 comprises a Boot ROM dll 311, a program module, loaded and executed by a processor, and a communication controller 312. The target device 320 comprises a baseband unit 321, a communication controller 322 and a flash memory 323. A target Boot ROM program 324 and a target download agent (DA) 325 is loaded and executed by a processor of the baseband unit 321. The Boot ROM dll 311 issues a request through communication controllers 312 and 322 to the target Boot ROM program 324 executed by the baseband unit 321 to direct the target device 320 to enter a download mode (1^{st} step). After the target device 320 enters the download mode, the Boot ROM program 324 responds with an ACK (acknowledgement) message to the Boot ROM dll 311 executed by the processor of the personal computer 300 to indicate that the target device has entered the download mode (2^{nd} step). When entering the download mode, the target device operates as a passive device been controlled by the personal computer 310. The Boot ROM dll 311 next transmits the download agent (DA) 325, a program module, to the target Boot ROM program 324, and then, the target Boot ROM program 324 stores the received DA 325 in internal memory (not shown) thereof, and directs a processor of the baseband unit 321 to load and execute the stored DA 325 for subsequent process (3^{rd} step). The target DA 325, while executing, initiates the flash memory 323 (4^{th} step). The Boot ROM dll 311 transmits image BIN files to the target DA 325 packet by packet (5^{th} step). The target DA 325 sequentially programs the received data of packets, may also refer to as segments of BIN files, in a predetermined region of the flash memory 323 (6^{th} step). The target DA 325 periodically transmits ACK messages to the Boot ROM dll, each indicating that data of a certain amount of packets has been successfully programmed in the flash memory 323 (7^{th} step).

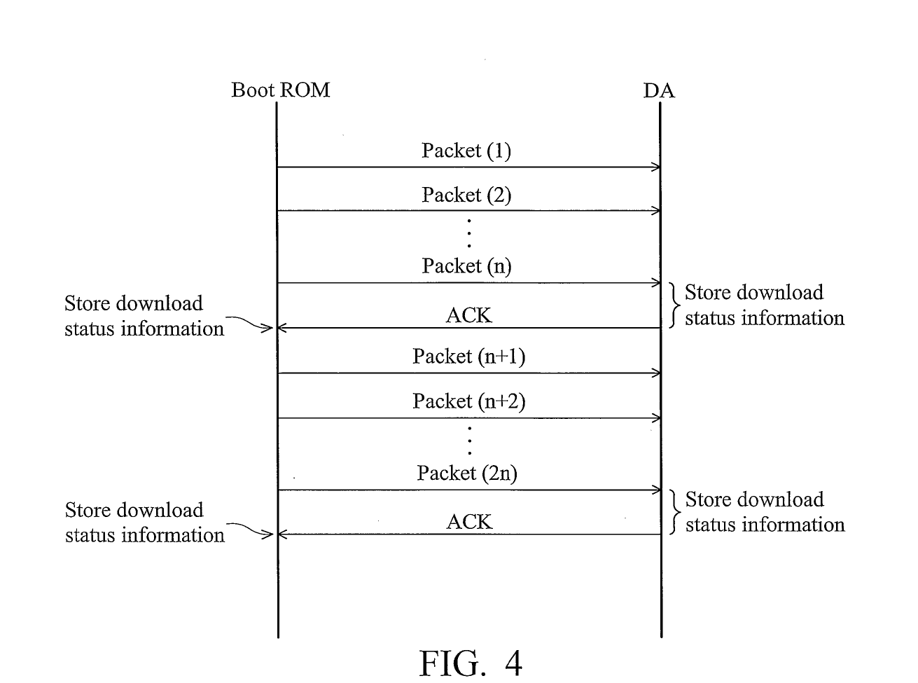

FIG. 4 is a sequence diagram illustrating an image BIN file downloaded between the executed Boot ROM dll 311 and target DA 325 according to an embodiment of the invention. The Boot ROM dll 311 transmits multiple packets corresponding to one BIN file to the target DA 325 and receives ACK (acknowledgement) messages from the target DA 325. After the Boot ROM dll 311 successfully transmits n packets to the DA 325 and then the DA 325 successfully programs data of the received packets in a continuous region of a nonvolatile memory (e.g. the flash memory 323) and updates relevant information regarding download statuses of the nonvolatile memory, such as “BIN_Index” and “Packet_Index”, for indicating that the received data has been completely programmed in the nonvolatile memory of target device 320, the target DA 325 transmits a ACK message to the Boot ROM dll 311. It is to be understood that “n” can be configured to a value larger than one in order to reduce frequencies of download status storage. The Boot ROM dll 311 may also store the information regarding download statuses for indicating that the transmitted data has been successfully programmed in the nonvolatile storage device of the target device 320 for synchronization of download status after receiving a ACK message.

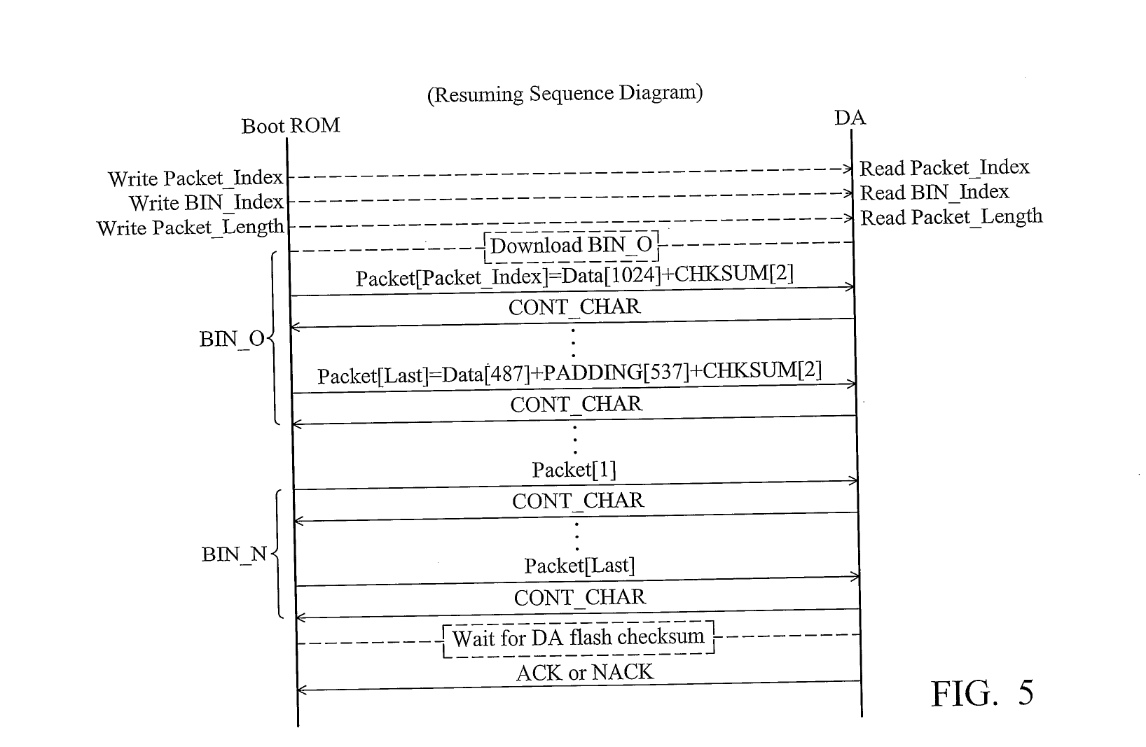

It is to be understood that the image BIN file download illustrated in FIG. 4 may be exceptionally interrupted due to power failure, transmission port jam, or others. FIG. 5 is a sequence diagram of illustrating download resuming between the executed Boot ROM dll 311 and target DA 325 according to an embodiment of the invention. After fixing the exceptional situation, information regarding the last download statuses is acquired by both the Boot ROM dll 311 and the DA 315. In FIG. 5, the Boot ROM dll 311 determines the remaining portion of data of a BIN file to be downloaded, and transmits information regarding a resuming point for the remaining portion of data of the BIN file (e.g. “Bin_Index” identifying a BIN file, “Packet_Index” indicating a serial number of packets of the BIN file, “Packet_Length” indicating a data length in each packet) to the DA 315, and then the DA 315 calculates a resuming address of the nonvolatile memory accordingly. Note that information regarding the last download statuses may be retrieved from a storage device of the download device 310 or requested from the target device 320. In some embodiments, those skilled in the art may realize that the DA 325 determines the remaining portion of data of a BIN file to be downloaded according to the stored information regarding the last download statuses, and transmits information regarding a resuming point for the remaining portion of data of the BIN file to the Boot ROM dll 311.

The resuming address is calculated according to the acquired “BIN_Index”, “Packet_Index” and “Packet_Length”. For example, the resuming address is OFFSET[BIN_Index]+Packet_Index*Packet_Length, where OFFSET[BIN_Index] is a start address of a BIN file identified by the “BIN_Index”. The Boot ROM dll 311 segments the remaining BIN file or files into payloads of “Packet_Length” such as 1024 bytes, encapsulates payloads into packets, and sequentially transmits packets through communication controllers 312 and 322 to the DA 325 of target device 320. The DA 325 sequentially programs the received data of packets from the resuming address of the nonvolatile memory (e.g. the flash memory 323) of the target device 320. After the DA 325 receives a packet and programs data thereof successfully, the DA 325 transmits a message “CONT_CHAR” indicating that the received packet is completely processed. Thereafter, the Boot ROM dll 311 continues to transmit the remaining packets until the remaining BIN file or files are completely downloaded and programmed. After which, the DA 325 transmits a ACK or NACK (not acknowledgement) message to the Boot ROM dll 311 for respectively indicating success or fail of the entire download process. In spite of packet data of 1024 bytes as an example, moreover, each packet may further comprise 2 bytes checksum for ensuring the packet data is correctly transmitted to a target device. Details of checksum are well-known in the art, and briefly described herein. For the last packet of a BIN file, the remaining data may be fewer than 1024 bytes, thus, the rest of payload may be filled with zeros, called padding. As shown in FIG. 5, the last packet for a BIN file identified by “BIN_O” comprises BIN file data of 487 bytes, padding of 537 bytes and checksum of 2 bytes.

According to the above embodiment of the invention, the Boot ROM dll 311 acquires download status indicating that a portion of the file has been successfully programmed in nonvolatile memory of the target device, determines a resuming point of the file according to the acquired download status and transmits a portion of the file from the determined resuming point to the target device via a communication controller.

The DA 325 acquires a portion of the file from a source device (e.g. personal computer 310) via a communication controller, programs the acquired portion of the file in a predetermined region of the nonvolatile memory, and stores a download status indicating that the portion of the file has been successfully programmed in the nonvolatile memory. The embodiment of the invention avoids the programmed portion of the file to be re-acquired and re-programmed after occurring an unexpected event (power failure, communication port jam or others) has occurred.

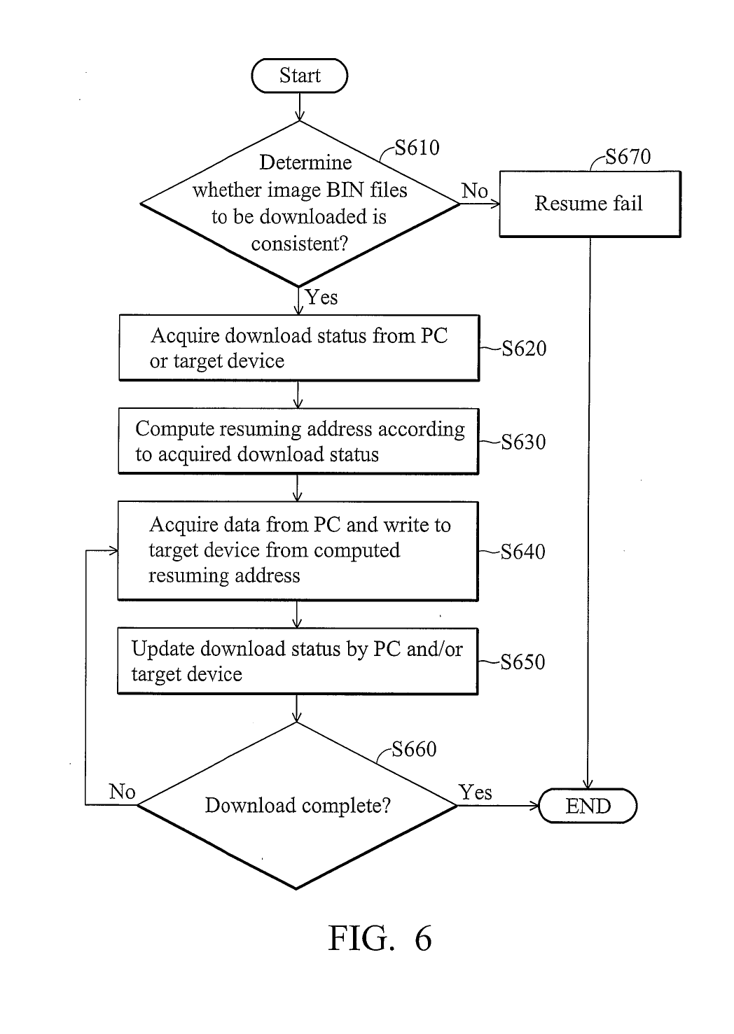

FIG. 6 is a flowchart illustrating download resuming according to an embodiment of the invention. The Boot ROM dll 311 or target DA 325 determines whether image BIN files to be downloaded is consistent with image BIN files stored in nonvolatile memory of a target device (step S610). The determination may be achieved by comparing file names, dates and/or versions of image BIN files to be downloaded with that of the stored image BIN files. If they are consistent, the download statuses stored in a PC (e.g. 310 of FIG. 3) or a target device (e.g. 320 of FIG. 3) are acquired (step S620). If they are not consistent, the resuming process fails (step S670). A resuming address is computed by the target device according to acquired download status (step S630). The remaining portion of image BIN files is acquired from the PC and is written to a continuous region of the nonvolatile memory of target device (e.g. 323 of FIG. 3) from the computed resuming address (a loop of steps S640 to S660). The download status is updated by the PC and/or target device if necessary (step S650). It is determines whether the entire download process is completed or not by the PC or target device (step S660). If not, the process proceeds to step S640 to acquire another data.

Communication controllers 312 and 322 can be a serial interface controller, such as RS232, RS242, serial ATA (SATA), universal serial bus (USB), IEEE 1394 or universal asynchronous receiver transmitter (UART), or a parallel interface controller, such as integrated drive electronics (IDE), small computer system interface (SCSI) or IEEE 1284. Target device 320 can be a mobile phone, smart phone, personal digital access (PDA) or digital camera. Those skilled in the art will realize that a serial interface controller transfers information in or out one bit at a time. Those skilled in the art will also realize that a parallel interface controller transfers data in or out in parallel, that is, using more than one wire, and carries one bit on each wire thus multiplying the transfer rate obtainable over a single cable.

While the invention has been described by way of example and in terms of preferred embodiment, it is to be understood that the invention is not limited to thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An apparatus for providing a file to a target device, comprising:
a communication controller; and
a processor acquiring download status indicating that a portion of the file has been successfully programmed in nonvolatile memory of the target device, determining a resuming point of the file according to the acquired download status, and transmitting a portion of the file from the determined resuming point to the target device via the communication controller,
whereby enabling the portion of file to be programmed in the nonvolatile memory of the target device.

2. The apparatus as claimed in claim 1, wherein the processor segments the file into a plurality of payloads, encapsulates the segmented payloads into a plurality of packets and transmits the file to the target device packet by packet.

3. The apparatus as claimed in claim 2, wherein the download status comprises a packet index indicating one of the payloads, the indicated payload and the payloads prior to the indicated payload are successfully programmed in the nonvolatile memory of the target device before occurring an exceptional event, and the resuming point represents the payload next to the indicated payload.

4. The apparatus as claimed in claim 1, wherein the download status is stored in the apparatus.

5. The apparatus as claimed in claim 1, wherein the download status is requested from the target device.

6. The apparatus as claimed in claim 1, wherein the file comprises an operation system (OS) of the apparatus.

7. The apparatus as claimed in claim 1, wherein the processor issues a request to the target device to direct the target device to enter a download, and transmits the file after receiving an acknowledgement message in response to the request.

8. The apparatus as claimed in claim 7, wherein the processor transmits a download agent to the target device after receiving the acknowledgement message, the download agent is executed by a processor of the target device, and the download agent, while executing, handles a process for downloading the file from the apparatus, and communication with the apparatus during downloading the file.

9. The apparatus as claimed in claim 1, wherein the processor segments the file into a plurality of payloads, encapsulates the segmented payloads into a plurality of packets and transmits the file to the target device packet by packet, the download status comprises a packet index indicating one of the payloads, and the processor further stores the packet index after receiving an acknowledgement message from the target device, indicating that the indicated payload is completely processed.

10. The apparatus as claimed in claim 9, wherein the acknowledgement message is periodically issued when the target device has successfully programmed two or more payloads.

11. An apparatus for receiving a file from a source device, comprising:
a communication controller;
a nonvolatile memory; and
a processor acquiring a portion of the file from the source device via the communication controller, programming the acquired portion of the file in a predetermined address of the nonvolatile memory, and storing a download status indicating that the portion of the file has been successfully programmed in the nonvolatile memory,
thereby avoiding the programmed portion of the file to be re-acquired and re-programmed after an unexpected event has occurred.

12. The apparatus as claimed in claim 11, wherein an exceptional situation is occurred after storing the download status, and the processor acquires the download status after fixing the exceptional situation, calculates a resuming address according to the acquired download status, acquires the remaining portion of the file from the source device, and programming the remaining portion of the file in a continuous region of the nonvolatile memory from the calculated resuming address.

13. The apparatus as claimed in claim 12, wherein the source device segments the file into a plurality of payloads, encapsulates the segmented payloads into a plurality of packets and transmits the file to the device packet by packet, the download status comprises a packet index indicating one of the payloads, and the resuming address is OFFSET+Packet_Index*Packet_Length, “OFFSET” represents a start address of the file, “Packet_Index” represents the packet index, and “Packet_Length” represents a length for each payload.

14. The apparatus as claimed in claim 11, wherein the download status further comprises a first file name or a first version of the file, an exceptional situation is occurred after storing the download status, and the processor determines whether a second filename or a second version of a file to be download is consistent with the first filename or the first version after fixing the exceptional situation, and terminates a resuming process for downloading the remaining portion of the file from the source device when determining the second filename or the second version is inconsistent with the first filename or the first version.

15. The apparatus as claimed in claim 11, wherein the file comprises a background image, an iconic image or font characters for UI display.

16. The apparatus as claimed in claim 11, wherein the file comprises an audio bitstream played when detecting an incoming call from an associated base station.

17. The apparatus as claimed in claim 11, wherein the file is a binary file, each byte of the file holds one of 256 different binary codes.

18. The apparatus as claimed in claim 11, wherein the download status is stored in the end of nonvolatile memory.

19. The apparatus as claimed in claim 18, wherein the source device segments the file into a plurality of payloads, encapsulates the segmented payloads into a plurality of packets and transmits the file to the device packet by packet, and the processor updates download status after successfully programming two or more payloads in the nonvolatile memory.

20. The apparatus as claimed in claim 11, wherein the apparatus is a mobile phone, portable media player, smart phone, personal digital assistant (PDA) or digital camera.
